(19) United States
(12) Patent Application Publication
(10) Pub. No.: US 2013/0297457 A1
(43) Pub. Date: Nov. 7, 2013

(54) TRANSFERABLE SHIPMENTS

(71) Applicant: Joe Yunzhou Zhu, Johns Creek, GA (US)

(72) Inventor: Joe Yunzhou Zhu, Johns Creek, GA (US)

(73) Assignee: UNITED PARCEL SERVICE OF AMERICA, INC., ATLANTA, GA (US)

(21) Appl. No.: 13/465,555

(22) Filed: May 7, 2012

(51) Int. Cl. G06Q 10/08; G06Q 30/06

(52) U.S. Cl. 705/26.81

(57) ABSTRACT

Systems, methods, apparatus, and computer program products are provided for transferable shipments. For example, in various embodiments, items being transported by a carrier can be re-routed after shipment from the consumer who originally purchased the item to another consumer.

### BACKGROUND

Consumers are increasing their expectations with regard to their ability purchase items and have the items delivered to them in an expedited manner. Thus, new concepts are needed to satisfy consumer expectations and improve the delivery experience.

### BRIEF SUMMARY

In general, embodiments of the present invention provide methods, apparatus, systems, computing devices, computing entities, and/or the like for providing items to consumers.

In accordance with one aspect, a method for providing items to consumers is provided. In one embodiment, the method comprises (1) providing, via one or more processors, at least one item available for purchase by one or more consumers; (2) completing, via the one or more processors, a transaction selling the at least one item to a first consumer; (3) indicating, via the one or more processors, the at least one item sold to the first consumer as being transferable, wherein indicating the item as being transferable comprises (a) indicating a delivery area associated with the delivery location of the first consumer, (b) indicating a time period for which the at least one item is transferable; (4) providing, via the one or more processors, the at least one item available for transfer to one or more consumers; and (5) completing, via the one or more processors, a transaction transferring the at least one item to a second consumer after shipment of the at least one item has begun.

In accordance with another aspect, a computer program product for providing items to consumers is provided. The computer program product may comprise at least one computer-readable storage medium having computer-readable program code portions stored therein, the computer-readable program code portions comprising executable portions configured to (1) provide at least one item available for purchase by one or more consumers; (2) complete a transaction selling the at least one item to a first consumer; (3) indicate the at least one item sold to the first consumer as being transferable, wherein indicating the item as being transferable comprises (a) indicating a delivery area associated with the delivery location of the first consumer, (b) indicating a time period for which the at least one item is transferable; (4) provide the at least one item available for transfer to one or more consumers; and (5) complete a transaction transferring the at least one item to a second consumer after shipment of the at least one item has begun.

In accordance with yet another aspect, an apparatus comprising at least one processor and at least one memory including computer program code is provided. In one embodiment, the at least one memory and the computer program code may be configured to, with the processor, cause the apparatus to (1) provide at least one item available for purchase by one or more consumers; (2) complete a transaction selling the at least one item to a first consumer; (3) indicate the at least one item sold to the first consumer as being transferable, wherein indicating the item as being transferable comprises (a) indicating a delivery area associated with the delivery location of the first consumer, (b) indicating a time period for which the at least one item is transferable; (4) provide the at least one item available for transfer to one or more consumers; and (5) complete a transaction transferring the at least one item to a second consumer after shipment of the at least one item has begun.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is an overview of a system that can be used to practice embodiments of the present invention.

FIG. 2 is an exemplary schematic diagram of a retailer system according to one embodiment of the present invention.

FIG. 3 is an exemplary schematic diagram of a mobile station according to one embodiment of the present invention.

FIG. 4 is a flowchart illustrating operations and processes that can be used in accordance with various embodiments of the present invention.

### DETAILED DESCRIPTION

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

### I. COMPUTER PROGRAM PRODUCTS, METHODS, AND COMPUTING ENTITIES

Embodiments of the present invention may be implemented in various ways, including as computer program products. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, program code, and/or similar terms used herein interchangeably). Such non-transitory computer-readable storage media include all computer-readable media (including volatile and non-volatile media), with the sole exception being a transitory, propagating signal.

In one embodiment, a non-volatile computer-readable storage medium may include a floppy disk, flexible disk, hard disk, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory, multimedia memory cards (MMC), secure digital (SD) memory cards, Memory Sticks, and/or the like. Further, a non-volatile computer-readable storage medium may also include conductive-bridging random access memory (CBRAM), phase-change random access memory (PRAM), ferroelectric random-access memory (FeRAM), resistive random-access memory (RRAM), Silicon-Oxide-Nitride-Oxide-Silicon memory (SONOS), racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Rambus in-line memory module (RIMM), dual in-line memory module (DIMM), single in-line memory module (SIMM), video random access memory VRAM, cache memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. However, embodiments of the present invention may also take the form of an entirely hardware embodiment performing certain steps or operations.

Embodiments of the present invention are described below with reference to block diagrams and flowchart illustrations. Thus, it should be understood that each block of the block diagrams and flowchart illustrations, respectively, may be implemented in the form of a computer program product, an entirely hardware embodiment, a combination of hardware and computer program products, and/or apparatus, systems, computing devices, computing entities, and/or the like carrying out instructions on a computer-readable storage medium for execution. Such embodiments can produce specifically-configured machines performing the steps or operations specified in the block diagrams and flowchart illustrations. Accordingly, the block diagrams and flowchart illustrations support various combinations of embodiments for performing the specified steps or operations.

### II. EXEMPLARY SYSTEM ARCHITECTURE

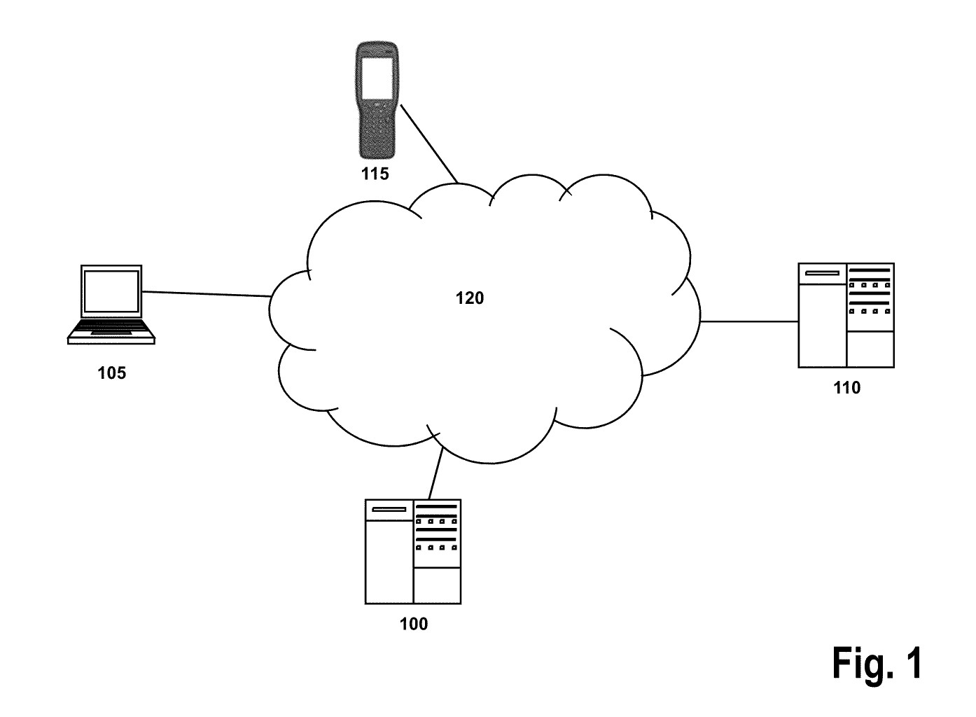

FIG. 1 provides an illustration of an exemplary embodiment of the present invention. As shown in FIG. 1, this particular embodiment may include one or more retailer systems 100, consumer computing devices 105, one or more carrier systems 110, one or more mobile stations 115, and one or more networks 120. Each of these components may be in direct or indirect communication with, for example, one another over the same or different wired or wireless networks. Additionally, while FIG. 1 illustrates the various system entities as separate, standalone entities, the various embodiments are not limited to this particular architecture.

### 1. Exemplary Retailer System

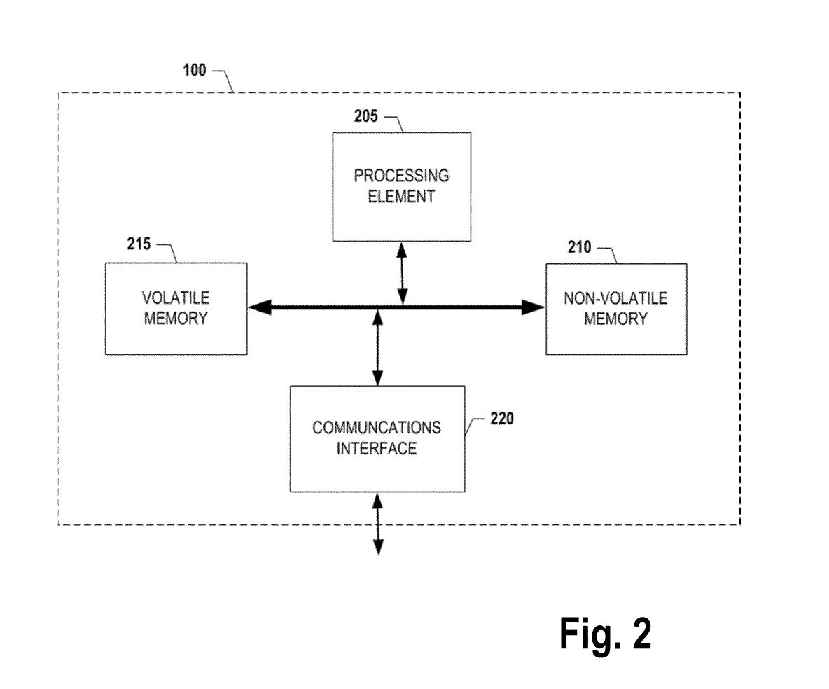

FIG. 2 provides a schematic of a retailer system 100 according to one embodiment of the present invention. In general, the term system may refer to, for example, one or more computers, computing devices, computing entities, mobile phones, desktops, tablets, notebooks, laptops, distributed systems, servers, blades, gateways, switches, processing devices, processing entities, relays, routers, network access points, base stations, the like, and/or any combination of devices or entities adapted to perform the functions described herein. A retailer may be any entity selling, purchasing, and/or facilitating the sale or purchase of items. For example, retailers may include entities such as Amazon (www.amazon.com), Target (www.target.com), and/or the like.

As shown in FIG. 2, in one embodiment, the retailer system 100 may include or be in communication with one or more processing elements 205 (also referred to as processors, processing circuitry, and/or similar terms used herein interchangeably) that communicate with other elements within the retailer system 100 via a bus, for example. As will be understood, the processing element 205 may be embodied in a number of different ways. For example, the processing element 205 may be embodied as one or more complex programmable logic devices (CPLDs), microprocessors, multi-core processors, coprocessing entities, application-specific instruction-set processors (ASIPs), and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the retailer system 100 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 210 as described above, such as hard disks, ROM, PROM, EPROM, EEPROM, flash memory, MMCs, SD memory cards, Memory Sticks, CBRAM, PRAM, FeRAM, RRAM, SONOS, racetrack memory, and/or the like. As will be recognized, the non-volatile storage or memory media may store databases, database management systems, data, applications, programs, program modules, scripts, source code, object code, byte code, compiled code, interpreted code, machine code, executable instructions, and/or the like.

In one embodiment, the retailer system 100 may further include or be in communication with volatile media (also referred to as volatile storage, memory, memory storage, memory circuitry and/or similar terms used herein interchangeably). In one embodiment, the volatile storage or memory may also include one or more volatile storage or memory media 215 as described above, such as RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. As will be recognized, the volatile storage or memory media may be used to store at least portions of the databases, database management systems, data, applications, programs, program modules, scripts, source code, object code, byte code, compiled code, interpreted code, machine code, executable instructions, and/or the like being executed by, for example, the processing element 205. Thus, the databases, data, applications, programs, program modules, scripts, source code, object code, byte code, compiled code, interpreted code, machine code, executable instructions, and/or the like may be used to control certain aspects of the operation of the retailer system 100 with the assistance of the processing element 205, database management system, and operating system, such as providing a website, webpage, portal, and similar terms used herein interchangeably through which items may be viewed, browsed, researched, purchased, sold, and/or the like.

As indicated, in one embodiment, the retailer system 100 may also include one or more communications interfaces 220 for communicating with various computing entities, such as by communicating data, content, information, and/or similar terms used herein interchangeably that can be transmitted, received, operated on, processed, displayed, stored, and/or the like. For instance, the retailer system 100 may communicate with consumer computing devices 105 (e.g., operated by consumers) to effect the sale, purchase, or facilitation of the sale or purchase of items. Further, the retailer system 100 may communicate with carrier systems 110 to carry out the transportation and delivery of items sold or purchased via the retailer. Such communication may be executed using a wired data transmission protocol, such as fiber distributed data interface (FDDI), digital subscriber line (DSL), Ethernet, asynchronous transfer mode (ATM), frame relay, data over cable service interface specification (DOC SIS), or any other wired transmission protocol. Similarly, the retailer system 100 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), 802.16 (WiMAX), ultra wideband (UWB), infrared (IR) protocols, Bluetooth™ protocols, wireless universal serial bus (USB) protocols, and/or any other wireless protocol. Commonly, such communication may be executed using hypertext transfer protocol (HTTP) via the World Wide Web (WWW) using wired and/or wireless technologies.

Although not shown, the retailer system 100 may include or be in communication with one or more input elements, such as a keyboard input, a mouse input, a touch screen/display input, audio input, pointing device input, joystick input, keypad input, and/or the like. The retailer system 100 may also include or be in communication with one or more output elements (not shown), such as audio output, video output, screen/display output, motion output, movement output, and/or the like.

As will be appreciated, one or more of the retailer system's 100 components may be located remotely from other retailer system 100 components, such as in a distributed system. Furthermore, one or more of the components may be combined and additional components performing functions described herein may be included in the retailer system 100. Thus, the retailer system's 100 can be adapted to accommodate a variety of needs and circumstances.

### 2. Exemplary Consumer Computing Device

A consumer may be an individual, a family, a company, an organization, an entity, a department within an organization, a representative of an organization and/or person, and/or the like purchasing or selling items via a retailer. To do so, a consumer may operate a consumer computing device 105 that includes one or more components that are functionally similar to those of the retailer system 100. For example, in one embodiment, each consumer computing device 105 may include one or more processing elements, one or more display device/input devices, volatile and non-volatile storage or memory, and/or one or more communications interfaces. These architectures are provided for exemplary purposes only and are not limiting to the various embodiments. The term computing device may refer to one or more computers, computing devices, computing entities, mobile phones, desktops, tablets, notebooks, laptops, distributed systems, servers, blades, gateways, switches, processing devices, processing entities, relays, routers, network access points, base stations, the like, and/or any combination of devices or entities adapted to perform the functions described herein. As will be recognized, the consumer computing device 105 may include a web browser that allows the consumer to purchase items via a retailer system 100.

### 3. Exemplary Carrier System

A carrier may be any entity that can carry out or facilitate, through a transportation and logistics network, the transportation and/or delivery of items sold or purchased via the retailer, such as United Parcel Service (UPS). To assist in the transportation and/or delivery of items, one or more carrier systems 110 may be used. A carrier system 110 may include one or more components that are functionally similar to those of the retailer system 100. For example, in one embodiment, the carrier system 110 may include one or more processing elements, one or more display device/input devices, volatile and non-volatile storage or memory, and/or one or more communications interfaces. The carrier system 110 may also comprise various other systems, such as an Address Matching System (AMS), an Internet Membership System (IMS), a Consumer Profile System (CPS), a Package Center Information System (PCIS), a Customized Pickup and Delivery System (CPAD), a Web Content Management System (WCMS), a Notification Email System (NES), a Fraud Prevention System (FPS), and a variety of other systems and their corresponding components. Such carrier systems 110 may be in communication with retailer systems 100, consumer computing devices 105, and/or mobile stations 115.

### 4. Exemplary Mobile Station

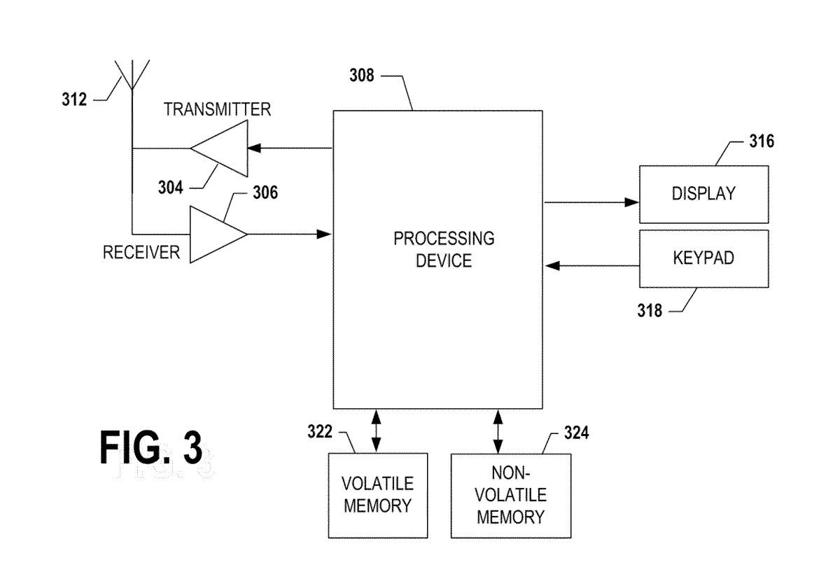

FIG. 3 provides an illustrative schematic representative of a mobile station 115 that can be used in conjunction with embodiments of the present invention. Mobile stations 115 can be operated by various parties, including carrier personnel such as delivery drivers, sorters, and/or the like. As shown in FIG. 3, the mobile station 115 can include an antenna 312, a transmitter 304 (e.g., radio), a receiver 306 (e.g., radio), and a processing element 308 (such as those described above with regard to the retailer system 100) that provides signals to and receives signals from the transmitter 304 and receiver 306, respectively.

The signals provided to and received from the transmitter 304 and the receiver 306, respectively, may include signaling information in accordance with an air interface standard of applicable wireless systems. In this regard, the mobile station 115 may be capable of operating with one or more air interface standards, communication protocols, modulation types, and access types. More particularly, the mobile station 115 may operate in accordance with any of a number of wireless communication standards and protocols, such as those described above with regard to the retailer system 100. In a particular embodiment, the mobile station 115 may operate in accordance with multiple wireless communication standards and protocols, such as UMTS, CDMA2000, 1xRTT, WCDMA, TD-SCDMA, LTE, E-UTRAN, EVDO, HSPA, HSDPA, Wi-Fi, WiMAX, UWB, IR, Bluetooth™, USB, and/or the like.

Via these communication standards and protocols, the mobile station 115 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The mobile station 115 can also download changes, add-ons, and updates, for instance, to its firmware, software (e.g., including executable instructions, applications, program modules), and operating system.

According to one embodiment, the mobile station 115 may include a location determining device and/or functionality. For example, the mobile station 115 may include a Global Positioning System (GPS) module adapted to acquire, for example, latitude, longitude, altitude, geocode, course, and/or speed data. In one embodiment, the GPS module acquires data, sometimes known as ephemeris data, by identifying the number of satellites in view and the relative positions of those satellites.

The mobile station 115 may also comprise a user interface (that can include a display 316 coupled to a processing element 308) and/or a user input interface (coupled to a processing element 308). The user input interface can comprise any of a number of devices allowing the mobile station 115 to receive data, such as a keypad 318 (hard or soft), a touch display, voice or motion interfaces, or other input device. In embodiments including a keypad 318, the keypad 318 can include (or cause display of) the conventional numeric (0-9) and related keys (#, *), and other keys used for operating the mobile station 115 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The mobile station 115 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database management systems, data, applications, programs, program modules, scripts, source code, object code, byte code, compiled code, interpreted code, machine code, executable instructions, and/or the like to implement the functions of the mobile station 115.

### III. EXEMPLARY SYSTEM OPERATION

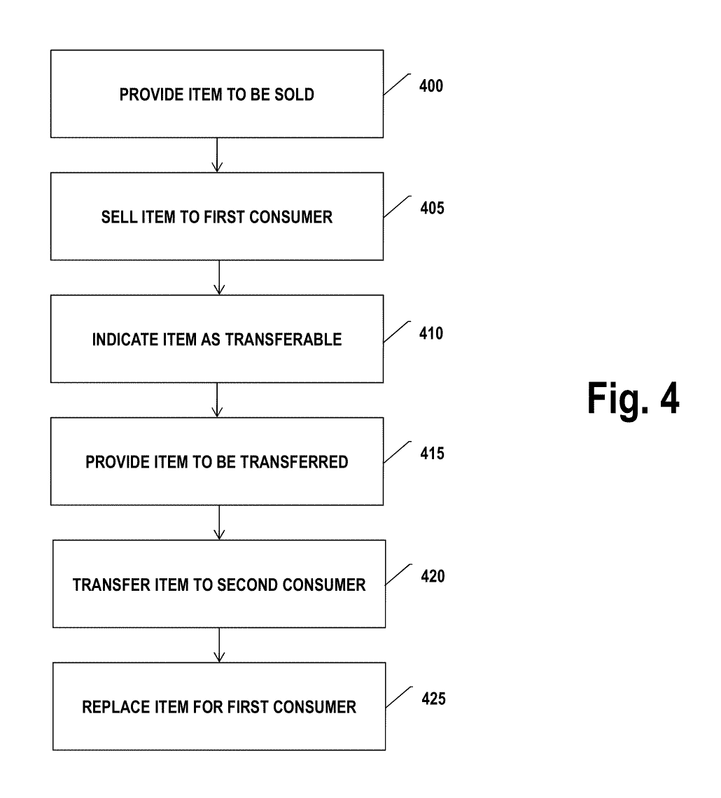

Reference will now be made to FIG. 4. FIG. 4 is a flowchart illustrating operations and processes that may be performed for providing items to consumers.

### 1. Registration

In one embodiment, the process may begin with the enrollment/registration of one or more consumers for an account with a retailer. To register, a consumer (e.g., operating a consumer computing device 105) may access a webpage or portal of a retailer (e.g., provided by a retailer system 100), such as www.amazon.com. As part of the enrollment/registration process, the retailer system 100 may request that the consumer provide biographic, financial, and/or geographic information. In response, the consumer (e.g., operating a consumer computing device 105) may provide the consumer's name, address, and/or other relevant information for enrollment/registration. For instance, John Doe may register for an account with www.amazon.com and include his name, credit card information, and 895 Peachtree Street, Atlanta, Ga. 30309, USA as his address. Similarly, Bob Smith may register for an account with www.amazon.com and enter his name, credit card information, and 1105 Main Street, Atlanta, Ga. 30309, USA as his address. Notably, the consumer may also have at least one preferred delivery destination address, in addition to the residential address.

In one embodiment, once the retailer system 100 receives the necessary biographic, financial, and/or geographic information from a consumer, the retailer system 100 may create a consumer profile for the consumer via the enrollment/registration process. Accordingly, the retailer system 100 may create and store various consumer profiles. In addition to at least the information described above, a consumer profile may include one or more corresponding usernames, passwords, and/or the like for authentication when the consumer logs on the website later. As will be recognized, various other approaches and techniques can be used to adapt to various needs and circumstances. For instance, in certain embodiments, enrollment/registration (or having an account with a retailer) may not be necessary to practice embodiments of the present invention.

### 2. Indicating Items as Transfer-Eligible

In one embodiment, the retailer system 100 can indicate specific items for sale as being “transfer-eligible.” Being transfer-eligible may be indicating that a particular item can be shipped using a transferrable delivery service (and be transferrable), such as Transferable Next Day Air, Transferable 2nd Day Air, Transferable 3 Day Select, Transferable Ground, and/or the like. Determining whether an item can be indicated as being transfer-eligible can be determined by the retailer, the carrier, or both. For instance, in one embodiment, a carrier may provide retailers with classes, categories, and/or lists of items that are transfer-eligible (e.g., can be shipped using transferrable delivery services). As will be recognized, a variety of other approaches and techniques can be used to adapt to various needs and circumstances.

### 3. Purchasing/Selling an Item

In one embodiment, as indicated in Block 400 of FIG. 4, consumers (e.g., operating consumer computing devices 105) can browse a retailer's website (e.g., webpages of the retailer can be provided, served, cause to be displayed, and similar words used herein interchangeably by the retailer system 100). In doing so, a consumer (e.g., operating a consumer computing device 105) can view and/or browse items that are available for purchase via a transaction through the retailer's website. Then, a consumer (e.g., operating a consumer computing device 105) can purchase such items with a transferrable shipping level/option or without a transferrable shipping level/option via a retailer's website (Block 405 of FIG. 4). To do so, a consumer can use an online shopping cart and checkout process, for instance, to complete the purchase/sales transaction. As part of the transaction, the consumer (e.g., operating a consumer computing device 105) can select from one of many shipping levels/options for delivery of the purchased item by a carrier such as UPS. For instance, the shipping levels/options for a carrier may include standard shipping levels/options, such as Next Day Air, 2nd Day Air, 3 Day Select, Ground, and/or the like. The shipping options for a carrier may also include transferable shipping levels/options, such as Transferable Next Day Air, Transferable 2nd Day Air, Transferable 3 Day Select, Transferable Ground, and/or the like. In one embodiment, only the items indicated as transfer-eligible qualify to be delivered with above transferable delivery services. As described, the retailer or carrier can limit the types and/or quantities of items that can be shipped using transferrable delivery services by indicating such items as transfer-eligible. For example, if a particular item is transfer-eligible, the retailer system 100 may provide the ability to select one of the transferrable delivery services. If, however, a particular item is not transfer-eligible the retailer system 100 would not provide or may “grey-out,” for example, the transferrable shipping options to the consumer upon checkout.

In one embodiment, via the transferable shipping levels/options, purchased items being transported by a carrier can be re-routed after shipment to a different consumer than the consumer who originally purchased the item. In such a case, the retailer can then send the original consumer a replacement item. If a consumer (e.g., operating consumer computing devices 105) chooses the items with transferable shipping option, the consumer is obligated to agree that ownership of the consignment is transferrable to another during delivery. Such ownership may include filing customs declaration, paying duties during the delivery time, and/or the like.

In one embodiment, as part of selecting one of the transferable shipping options, the consumer may be provided with a delivery date and/or time corresponding to the service level. For example, the retailer system 100 can provide, serve, and/or cause to be displayed delivery dates and times or time windows for delivery of the item. Such times and time windows may be estimated delivery times or time windows and/or confirmed delivery times or time windows. Table 1 below provides illustrative estimated delivery times or time windows and/or confirmed delivery times or time windows.

TABLE 1

| Estimated Delivery Windows | Confirmed Delivery Windows |
|---|---|
| 11:45 am-3:45 pm | 11:45 am-1:45 pm |
| | 12:45 pm-2:45 pm |
| | 1:45 pm-3:45 pm |
| 11:30 am-3:30 pm | 11:30 am-1:30 pm |
| | 12:30 pm-2:30 pm |
| | 1:30 pm-3:30 pm |
| 2:00 pm-5:45 pm | 2:00 pm-4:00 pm |
| | 3:45 PM-5:45 pm |
| 1:00 pm-4:15 pm | 1:00 pm-3:00 pm |
| | 2:15 pm-4:15 pm |
| 8:00 am-11:00 pm | 8:00 am-10:00 am |
| | 9:00 am-11:00 am |
| 3:00 pm-6:00 pm | 3:00 pm-5:00 pm |
| | 4:00 pm-6:00 pm |
| 3:00 pm-5:45 pm | 3:00 pm-5:00 pm |
| | 3:45 pm-5:45 pm |
| 4:00 pm-6:00 pm | 4:00 pm-6:00 pm |

Additional information regarding estimated delivery times or time windows and/or confirmed delivery times or time windows can be found in U.S. Pat. No. 6,701,299, U.S. Pat. No. 7,233,907, and U.S. Pat. No. 7,925,524, all of which are incorporated herein in their entireties by reference. As will be recognized, a variety of other operations and processes may be used with embodiments of the present invention. These operations and processes can be customized to adapt to various needs and circumstances.

The consumer (e.g., operating a consumer computing device 105) may also select a latest delivery date and/or time for delivery of the item being purchased. The latest delivery date and/or time may be used to indicate the latest date and/or time the consumer is willing to have the item delivered via the transferable shipping option. In yet another embodiment, the latest delivery date and/or time may be automatically provided by the retailer system 100 as an assurance to the consumer of the latest he or she can expect to receive the purchased item.

In one embodiment, as an incentive for using a transferable shipping option, the transferable shipping level/option may be provided at a reduced shipping rate, such as receiving 50% off the normal shipping rate if his or her item is transferred. In another embodiment, the transferable shipping level/option may provide the consumer with the opportunity to receive a full or partial refund of the shipping rate if his or her item is transferred. In yet another embodiment, the transferable shipping level/option may provide the consumer with the opportunity to earn credits or rewards for a rewards program if his or her item is transferred. As will be recognized, a variety of approaches and techniques can be used to adapt to various needs and circumstances.

Continuing with the example, assume John Doe (living in Atlanta, Ga.) browses items for purchase at www.amazon.com (e.g., via a consumer computing device 105) on Apr. 2, 2013. In doing so, Mr. Doe may purchase a Brand X watch for $60.00. In completing the transaction, the retailer system 100 can provide John (e.g., via a consumer computing device 105) with his shipping options, which may include transferable shipping options since the Brand X watch is marked as transfer-eligible via the website. In this example, John selects (e.g., via a consumer computing device 105) the Transferable Ground level/option with a delivery address of 1201 Peachtree Street, Atlanta, Ga. 30309, USA. As an additional part of completing the transaction, the retailer system 100 may provide an estimated delivery date and/or time of Apr. 6, 2013, by 3:30 pm. And either the retailer system 100 or Mr. Doe (e.g., via a consumer computing device 105) can provide a latest delivery date and/or time of Apr. 12, 2013, by 3:30 pm. As a final step of the order transaction, the Mr. Doe can complete the transaction and receive a confirmation that the transaction has been completed.

In one embodiment, after completing the purchase/sales transaction, the retailer system 100 can notify the appropriate carrier system 110 of parcels requiring shipment. The carrier may then arrange for transport and delivery of the parcels and begin shipment. For example, the retailer system 100 can notify the carrier system 110 that a parcel containing Mr. Doe's watch needs to be delivered. The carrier may then arrange for transport and delivery of the parcel containing Mr. Doe's watch and being shipment.

### 4. Indicating Items as Transferable

In one embodiment, the retailer system 100 can indicate items that are being shipped via the transferable shipping level/option as being transferable (Block 410 of FIG. 4). For such items, the retailer system 100 can also indicate the estimated or confirmed delivery date and/or time; the latest delivery date and/or time; the city, state, and/or geographic region in which the delivery location is located; the cities, states, and/or the geographic regions through which the item will be transported en route to the delivery location, and/or the relevant periods of time for which the item is transferable. Such indications may be referred to as transfer parameter indicators or similar terms words used herein interchangeably. Notably, in one embodiment, the carrier system 110 can provide transfer parameter indicators to the retailer system 100 for transfer-eligible items. In another embodiment, the retailer system 100 can provide transfer parameter indicators to the carrier system 110 for transfer-eligible items. Additionally, the carrier system 110 can inform the retailer system 100 of changes to the transfer parameter indicators, including newly added transfer parameter indicators or destroyed transfer parameter indicators. For example, the carrier system 110 can create a new transfer parameter indicator if the remaining delivery time is less than a threshold and/or destroy a transfer parameter indicator if the delivery process is near to closing or is finished. In other words, the carrier can maintain a transfer parameter indicator for delivering an item using a transferable delivery service for a certain time period.

Continuing with the above example, the retailer system 100 and/or carrier system 110 may create a transfer parameter indicator for Mr. Doe's watch as being transferable at 7:00 pm on Apr. 5, 2013. In one embodiment, once the retailer system 100 receives the new transfer parameter indicator with an estimated or confirmed delivery date and/or time of Apr. 6, 2013, by 3:30 pm, the retailer system 100 may tag an item of Brand X watch with the Atlanta delivery area as a transferable item with the transfer parameter indicator such that Mr. Doe's watch will be transferable to other consumers in the Atlanta, Ga. area from 7:00 pm on Apr. 5, 2013, to 2:00 pm on Apr. 6, 2013, given Mr. Doe's delivery location and the estimated or confirmed delivery date and/or time for the watch. In another embodiment, the retailer system 100 may also indicate the watch as being transferable to geographic locations proximate hubs or other centers through which the watch will be transported en route to Atlanta, Ga. For instance, if the carrier were scheduled to transport the watch through Memphis, Tenn. on Apr. 4, 2013, between 6:00 am and 11:30 am en route to Atlanta, Ga., the retailer system 100 may indicate Mr. Doe's watch as being transferable to consumers in the Memphis, Tenn. area from 6:00 am and 11:00 am on Apr. 4, 2013. As will be recognized, various other approaches and techniques can be used to adapt to various needs and circumstances. As will be appreciated, the retailer system 100 can handle conflicts for transferable items ordered by consumers. For example, if the carrier system 110 generates only one transferrable parameter indicator for Brand X watch for the Atlanta delivery area, and two other customers view such a transferable item at the same time, only one consumer could successfully transfer this transferable item.

### 5. Purchasing/Selling a Transferable Item

In one embodiment, as indicated in Block 415 of FIG. 4, the retailer system 100 can provide (e.g., webpages of the retailer can be provided, served, and/or cause to be displayed by the retailer system 100) items indicated as transferable to consumers via transfer transactions (e.g., purchase and re-route from the consumer who originally purchased the item). For example, operating a consumer computing device 105 can view and/or browse items indicated as transferable through the retailer's website. Such items may be viewed and/or browsed in accordance with transfer parameter indicators. For instance, the retailer system 100 may provide such items to be viewed and/or browsed based on delivery areas, delivery dates and/or times, and/or various other transfer parameter indicators. Via the retailer system 100, as indicated in Block 420 of FIG. 4, consumers (e.g., operating consumer computing devices 105) can complete transactions transferring such items even though shipment to an original purchaser has begun. As previously described, transferring an item comprises re-routing the item to a different consumer than the consumer who originally purchased the item. A replacement item can then be shipped to the consumer who originally purchased the item (Block 425 of FIG. 4).

Continuing with the above example, Amazon (e.g., via amazon.com) may provide the ability to view and/or browse items indicated as transferable in the Atlanta, Ga. area—including Mr. Doe's Brand X watch. Thus, for instance, on Apr. 5, 2013, at 11:07 pm, Bob Smith (e.g., operating a consumer computing device 105) can visit www.amazon.com to browse for an item for his wife's April 7 birthday. In particular, Mr. Smith (e.g., operating a consumer computing device 105) may view that Mr. Doe's Brand X watch for $60.00 is available for transfer to consumers in the Atlanta, Ga. area from 7:00 pm on Apr. 5, 2013, to 2:00 pm on Apr. 6, 2013. Mr. Smith may decide to transfer Mr. Doe's Brand X watch to give it to his wife as a birthday gift. Accordingly, Mr. Smith may complete a transaction via the retailer system 100 transferring Mr. Doe's Brand X watch (that has already been shipped) in a process similar to that of purchase/sales transaction. As part of completing the transaction transferring Mr. Doe's Brand X watch, Mr. Smith may be required to pay a fee, increased shipping rates, and/or the like. Similarly, Mr. Doe may likewise receive an incentive for having his item transferred.

In one embodiment, once the transaction is complete, the retailer system 100 can notify the carrier system 110 that the parcel containing Mr. Doe's Brand X watch needs to be re-routed to Mr. Smith's address of 1105 Main Street, Atlanta, Ga. 30309. The carrier system 110 may then notify mobile stations 115 or other carrier computing entities that the parcel containing Mr. Doe's Brand X watch needs to be re-routed. Accordingly, the parcel can be intercepted at some point in the carrier's transportation and logistics network and be re-routed from Mr. Doe to Mr. Smith. For instance, on Apr. 6, 2013, at 4:33 am, a parcel sorter for the carrier may scan the parcel at a hub using a mobile station 105 before loading the parcel on a delivery vehicle for delivery to Mr. Doe. At that time, the mobile station 105 may provide a notification to the parcel sorter that the parcel needs to be relabeled (with a new consignee name and address) and placed on a different delivery vehicle for delivery to Mr. Smith. In one embodiment, the parcel sorter can then re-label the parcel and properly place the item for delivery to Mr. Smith.

In one embodiment, in addition to transferring the items, the retailer system 100 can initiate shipment of a replacement item for items that have been transferred. For example, the retailer system 100 can initiate shipment of a replacement Brand X watch to Mr. Doe and notify the appropriate carrier system 110 of the parcel containing Mr. Doe's replacement watch. The carrier may then arrange for transport and delivery of the parcel containing the replacement watch and begin shipment. The service level/option of the parcel containing the replacement watch may depend on the latest delivery date and/or time for delivery for Mr. Doe's watch. For instance, if there is sufficient time (e.g., based on the latest delivery date and/or time), the parcel containing the replacement watch may be shipped using Transferable Next Day Air, Transferable 2nd Day Air, Transferable 3 Day Select, Transferable Ground, and/or the like. If there is not sufficient time (e.g., based on the latest delivery date and/or time) or it would otherwise be advantageous to only have one transfer (or another configurable number of transfers) per sales/purchase transaction, the parcel containing the replacement item may be shipped using service levels/options such as Next Day Air, 2nd Day Air, 3 Day Select, Ground, and/or the like. As will be recognized, various approaches and techniques can be used to adapt to different needs and circumstances.

### 6. Strategically Located Facilities

In one embodiment, in addition to the features described above, the carrier and/or retailer may strategically deliver items to its region handling facilities based on daily historical shipments and/or data mining. These handling facilities can be considered as, for example, dummy consumers who order predicted items with transferable delivery services. Since the items shipped to the dummy consumers are guaranteed to be transferred to the second consumer with very high probability, the retailer and the carrier may have an agreement such that the purchase fee does not need to be paid until the item is transferred to a second or a third customer. For example, a carrier facility may be located in Atlanta, Ga., and store a specific number of Brand X watches based on the number of Brand X watches, for instance, that have been shipped to consumers in Atlanta during a specific time period. With such a strategically located and stocked facility, the carrier may be able to provide items to consumers with minimal delay. Such strategically located and stocked facilities may also be used with the features described above. As should be appreciated, after an item is transferred to a second consumer and a replacement item is shipped to the first customer, if the delivery time specified by the first consumer is still met, it is possible that the replacement item will be transferred to a third consumer and another replacement item will be delivered to the first consumer.

### IV. CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method for providing items to consumers, the method comprising:
providing, via one or more processors, at least one item available for purchase by one or more consumers;
completing, via the one or more processors, a transaction selling the at least one item to a first consumer;
indicating, via the one or more processors, the at least one item sold to the first consumer as being transferable, wherein indicating the item as being transferable comprises (a) indicating a delivery area associated with the delivery location of the first consumer, (b) indicating a time period for which the at least one item is transferable;
providing, via the one or more processors, the at least one item available for transfer to one or more consumers; and
completing, via the one or more processors, a transaction transferring the at least one item to a second consumer after shipment of the at least one item has begun.

2. The method of claim 1, wherein the delivery location of the first consumer and the delivery location of the second consumer are within or proximate the same delivery area.

3. The method of claim 1 further comprising notifying a carrier system of the at least one item to be delivered to the first consumer.

4. The method of claim 3 further comprising notifying the carrier system of the at least one item to be transferred to the second consumer.

5. The method of claim 1, wherein the first consumer is provided with an incentive for allowing the at least one item to be transferred.

6. An apparatus comprising at least one processor and at least one memory including computer program code, the at least one memory and the computer program code configured to, with the processor, cause the apparatus to at least:
provide at least one item available for purchase by one or more consumers;
complete a transaction selling the at least one item to a first consumer;
indicate the at least one item sold to the first consumer as being transferable, wherein indicating the item as being transferable comprises (a) indicating a delivery area associated with the delivery location of the first consumer, (b) indicating a time period for which the at least one item is transferable;
provide the at least one item available for transfer to one or more consumers; and
complete a transaction transferring the at least one item to a second consumer after shipment of the at least one item has begun.

7. The apparatus of claim 6, wherein the delivery location of the first consumer and the delivery location of the second consumer are within or proximate the same delivery area.

8. The apparatus of claim 6, wherein the memory and computer program code are further configured to, with the processor, cause the apparatus to notify a carrier system of the at least one item to be delivered to the first consumer.

9. The apparatus of claim 8, wherein the memory and computer program code are further configured to, with the processor, cause the apparatus to notify the carrier system of the at least one item to be transferred to the second consumer.

10. The apparatus of claim 6, wherein the first consumer is provided with an incentive for allowing the at least one item to be transferred.

11. A computer program product for providing items to consumers, the computer program product comprising at least one non-transitory computer-readable storage medium having computer-readable program code portions stored therein, the computer-readable program code portions comprising:
an executable portion configured to provide at least one item available for purchase by one or more consumers;
an executable portion configured to complete a transaction selling the at least one item to a first consumer;
an executable portion configured to indicate the at least one item sold to the first consumer as being transferable, wherein indicating the item as being transferable comprises (a) indicating a delivery area associated with the delivery location of the first consumer, (b) indicating a time period for which the at least one item is transferable;
an executable portion configured to provide the at least one item available for transfer to one or more consumers; and
an executable portion configured to complete a transaction transferring the at least one item to a second consumer after shipment of the at least one item has begun.

12. The computer program product of claim 11, wherein the delivery location of the first consumer and the delivery location of the second consumer are within or proximate the same delivery area.

13. The computer program product of claim 11 further comprising an executable portion configured to notify a carrier system of the at least one item to be delivered to the first consumer.

14. The computer program product of claim 13 further comprising an executable portion configured to notify the carrier system of the at least one item to be transferred to the second consumer.

15. The computer program product of claim 11, wherein the first consumer is provided with an incentive for allowing the at least one item to be transferred.
